(19) United States
(12) Patent Application Publication
(10) Pub. No.: US 2024/0316816 A1
(43) Pub. Date: Sep. 26, 2024

(54) LOCKING STRUCTURE OF MULTI-FUNCTIONAL VEGETABLE CUTTER

(71) Applicant: Congqiang LU, Taizhou (CN)

(72) Inventor: Congqiang LU, Taizhou (CN)

(21) Appl. No.: 18/607,143

(22) Filed: Mar. 15, 2024

(30) Foreign Application Priority Data
Mar. 24, 2023 (CN) 202320653506.7

(51) Int. Cl. B26D 7/22; B26D 7/24

(52) U.S. Cl. CPC B26D 7/225; B26D 7/24

(57) ABSTRACT

Disclosed is a locking structure of a multi-functional vegetable cutter including a housing and a sliding bracket. The sliding bracket is slidably disposed in the housing, an upper end of the sliding bracket is provided with a chute with an opening on a front side, a locking block extendable from the opening on the front side is slidably disposed in the chute, a rear side of the locking block is provided with a cam hinged on the sliding bracket, the cam is in abutting connection with a rear end face of the locking block, when rotating, the cam drives the locking block to slide forward and lock the sliding bracket, and the locking block is connected to a reset mechanism driving the locking block to slide backward.

### CROSS-REFERENCE TO RELATED APPLICATIONS

This application claims priority to Chinese Patent Application No. 202320653506.7, filed on Mar. 24, 2023, the content of which is incorporated herein by reference in its entirety.

### TECHNICAL FIELD

The present disclosure relates to the technical field of vegetable cutters, and relates to a locking structure of a multi-functional vegetable cutter.

### BACKGROUND

A vegetable cutter is a common food processing device used for cutting food. A multi-functional vegetable cutter can cut food into slices or shreds as needed to meet different requirements.

For example, Chinese Utility Model Patent Publication No. CN208629506U discloses a food cutter. The food cutter includes a housing and a cutting mechanism. The cutting mechanism includes a cutting portion and a pulling portion configured to control the cutting portion to move back and forth. The cutting portion includes a sliding member, a first knife, and a plurality of second knives. The sliding member is slidably connected to the housing, and in a process of the pulling portion pulling the sliding member to move back and forth, the food can be cut into slices.

For convenient storage of the vegetable cutter, the sliding member needs to be locked onto the housing during no use. For example, Chinese Utility Model Patent Publication No. CN213731992U discloses a handle of a food cutter, including a handle body. An end portion of the handle body is provided with a grip plate, and a grip cavity is formed between the grip plate and the handle body. The end portion of the handle body is further provided with a limiting structure that limits the sliding of the handle body along the food cutter. The limiting structure of the foregoing device needs to be equipped with a handle with a grip cavity for use, but the design of the handle with a grip cavity increases the longitudinal dimension of the vegetable cutter. Therefore, another locking structure needs to be designed to fit with a vegetable cutter with a shorter dimension.

### SUMMARY

In view of the defects in the prior art, the present disclosure provides a locking structure of a multi-functional vegetable cutter, which has advantages of a simple structure, convenient operation, and a small space occupied.

To resolve the foregoing technical problem, an objective of the present disclosure is achieved using the following technical solution.

The locking structure of a multi-functional vegetable cutter includes a housing and a sliding bracket. The sliding bracket is slidably disposed in the housing, an upper end of the sliding bracket is provided with a chute with an opening on a front side, a locking block extendable from the opening on the front side is slidably disposed in the chute, a rear side of the locking block is provided with a cam hinged on the sliding bracket, the cam is in abutting connection with a rear end face of the locking block, when rotating, the cam drives the locking block to slide forward and lock the sliding bracket, and the locking block is connected to a reset mechanism driving the locking block to slide backward.

In the foregoing locking structure of a multi-functional vegetable cutter, a rear side of the sliding bracket is provided with a cam seat, a camshaft is rotatably disposed in the cam seat, the cam is fixedly connected to the camshaft, the camshaft is further connected to a conversion handle, and a rear end of the conversion handle extends outside the cam seat. Further, an end portion of the camshaft is provided with an end portion plane, the cam is mounted on the end portion plane and synchronously rotates along with the camshaft, and the conversion handle and the camshaft are integrated.

In the foregoing locking structure of a multi-functional vegetable cutter, a rear side of the cam seat is detachably connected to a cover plate, the cover plate and the cam seat enclose a cam mounting chamber, and the cam and the camshaft are both located in the cam mounting chamber.

In the foregoing locking structure of a multi-functional vegetable cutter, the cam includes a long edge and a short edge, a transition between the long edge and the short edge is made through a curved edge, when the long edge abuts against the locking block, the sliding bracket is in an unlocked state, and when the short edge abuts against the locking block, the sliding bracket is in a locked state.

In the foregoing locking structure of a multi-functional vegetable cutter, two sides of the locking block extend outward to form a limiting seat, and a limiting structure is formed between the limiting seat and a front side wall of the chute. Preferably, the limiting seat extends left and right. Further, sliding rails are disposed on left and right sides of the chute, and the limiting seat is slidably disposed in the sliding rails.

In the foregoing locking structure of a multi-functional vegetable cutter, the reset mechanism is a reset spring, and the reset spring is disposed between the limiting seat and the front side wall of the chute. Further, the limiting seat and the front side wall of the chute are provided with a mounting pillar or a mounting groove for mounting the reset spring. The reset mechanism may alternatively be a draw spring, and the draw spring is disposed between the limiting seat and the cam seat.

In the foregoing locking structure of a multi-functional vegetable cutter, an upper end of the housing extends backward to form a flanging, and a lower side surface of the flanging abuts against an upper side surface of the locking block to form a locking structure. Alternatively, an upper end of the housing is provided with a locking groove, and the locking block fits with the locking groove to form a locking structure.

In the foregoing locking structure of a multi-functional vegetable cutter, the upper end of the sliding bracket is provided with a handheld portion exceeding the sliding bracket.

Compared with the prior art, the present disclosure has the following beneficial effect.

The present disclosure provides the locking structure of a vegetable cutter and the sliding bracket of the vegetable cutter can be locked on the housing for convenient storage of the vegetable cutter. With the change of the locking structure, arrangement no longer relies on the cavity structure on the sliding bracket, thus further shrinking the dimension of the sliding bracket. The present disclosure has advantages of a simple structure, convenient operation, and a small space occupied.

### BRIEF DESCRIPTION OF THE DRAWINGS

FIG. 1 is a three-dimensional diagram according to the present disclosure.

FIG. 2 is a three-dimensional diagram of a sliding bracket according to the present disclosure.

FIG. 3 is a cross-sectional view of FIG. 2.

FIG. 4 is another cross-sectional view of FIG. 2.

FIG. 5 is a three-dimensional diagram a locking block and a driving structure according to the present disclosure.

FIG. 6 is a three-dimensional diagram of a cam assembly according to the present disclosure.

### DETAILED DESCRIPTION OF THE EMBODIMENTS

The present disclosure is further described below with reference to the accompanying drawings and a specific embodiment.

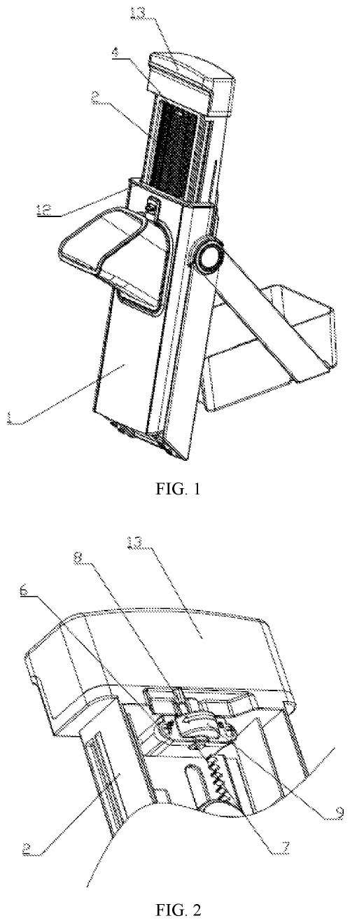

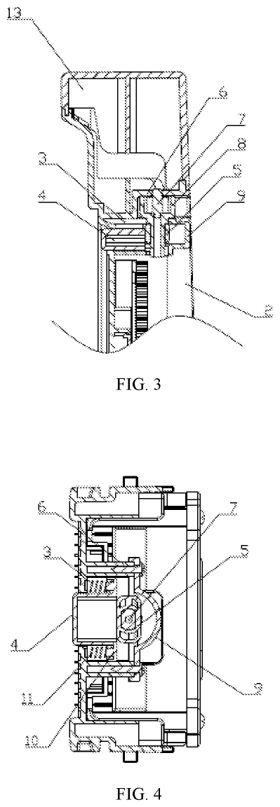

Referring to FIGS. 1 to 6, a locking structure of a multi-functional vegetable cutter is provided, including a housing 1 and a sliding bracket 2. The sliding bracket 2 is slidably disposed in the housing 1, an upper end of the sliding bracket 2 is provided with a chute 3 with an opening on a front side, a locking block 4 extendable from the opening on the front side is slidably disposed in the chute 3, a rear side of the locking block 4 is provided with a cam 5 hinged on the sliding bracket 2, the cam 5 is in abutting connection with a rear end face of the locking block 4, when rotating, the cam 5 drives the locking block 4 to slide forward and lock the sliding bracket 2, and the locking block 4 is connected to a reset mechanism driving the locking block to slide backward.

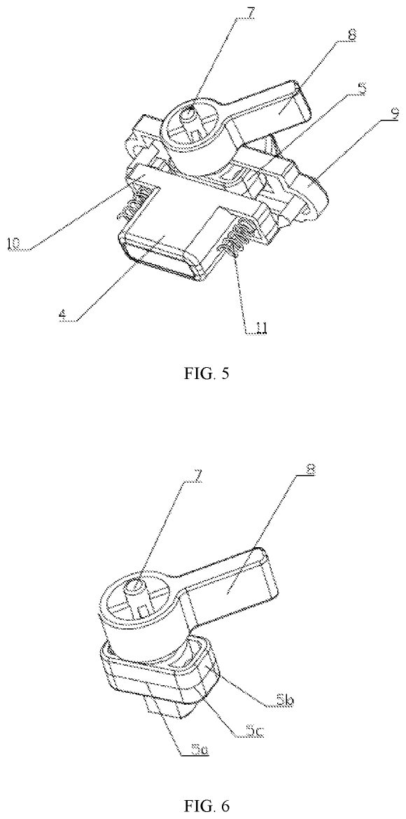

Referring to FIG. 5, a mounting and driving structure of the cam 5 in this embodiment is as follows: A rear side of the sliding bracket 2 is provided with a cam seat 6, a camshaft 7 is rotatably disposed in the cam seat 6, the cam 5 is fixedly connected to the camshaft 7, the camshaft 7 is further connected to a conversion handle 8, and a rear end of the conversion handle 8 extends outside the cam seat 6. Further, an end portion of the camshaft 7 is provided with an end portion plane, the cam 5 is mounted on the end portion plane and synchronously rotates along with the camshaft 7, and the conversion handle 8 and the camshaft 7 are integrated.

Further, for convenient mounting, a rear side of the cam seat 6 is detachably connected to a cover plate 9, the cover plate 9 and the cam seat 6 enclose a cam mounting chamber, and the cam 5 and the camshaft 7 are both located in the cam mounting chamber. During mounting, the locking block 4 and the camshaft 7 with the cam 5 and the conversion handle 8 are sequentially placed at the opening of the cam seat 6, and then the cover plate 9 is fixed.

Referring to FIG. 6, the specific structure of the cam 5 in this embodiment is as follows: The cam 5 includes a long edge 5a and a short edge 5b, a transition between the long edge 5a and the short edge 5b is made through a curved edge 5c, when the long edge 5a abuts against the locking block 4, the sliding bracket 2 is in an unlocked state, and when the short edge 5b abuts against the locking block 4, the sliding bracket 2 is in a locked state.

To prevent the locking block 4 from being separated from the chute 3, two sides of the locking block 4 extend outward to form a limiting seat 10, and a limiting structure is formed between the limiting seat 10 and a front side wall of the chute 3. Preferably, the limiting seat 10 extends left and right. Further, for more stable sliding of the locking block 4, sliding rails are disposed on left and right sides of the chute 3, and the limiting seat 10 is slidably disposed in the sliding rails.

Referring to FIG. 4, the structure of the reset mechanism in this embodiment is as follows: The reset mechanism is a reset spring 11, and the reset spring 11 is disposed between the limiting seat 10 and the front side wall of the chute 3. During forward movement of the locking block 4, the reset spring 11 is compressed, and during unlocking, the reset spring 11 drives the locking block 4 to be reset. Further, the limiting seat 10 and the front side wall of the chute 3 are provided with a mounting pillar or a mounting groove for mounting the reset spring 11. The reset mechanism may alternatively be a draw spring, and the draw spring is disposed between the limiting seat 10 and the cam seat 6. When the locking block 4 moves forward, the draw spring is stretched, and at the moment of unlocking, the draw spring drives the locking block 4 to be reset.

In this embodiment, a locking structure fitting with the locking block 4 on the housing 1 is as follows: An upper end of the housing 1 extends backward to form a flanging 12, and a lower side surface of the flanging 12 abuts against an upper side surface of the locking block 4 to form a locking structure. Alternatively, an upper end of the housing 1 is provided with a locking groove, and the locking block 4 fits with the locking groove to form a locking structure.

To conveniently operate the sliding bracket 2 for movement, the upper end of the sliding bracket 2 is provided with a handheld portion 13 exceeding the sliding bracket 2. During use, a hand holds the handheld portion 13 for convenient pull. Because no hollow cavity structure needs to be provided on the handheld portion 13, the handheld portion 13 may be designed shorter.

The locking and the unlocking manners in this embodiment are as follows: When locking is needed, the sliding bracket 2 is pushed downward, and then the conversion handle 8 is pulled in the locking direction. The conversion handle 8 drives the camshaft 7 and the cam 5 to move synchronously. When the cam 5 rotates, the portion abutting against the locking block 4 is converted gradually from the long edge 5a to the short edge 5b. During rotation, the cam 5 pushes the locking block 4 to move forward while the reset spring 11 is compressed. At the locking position, the short edge 5b of the cam 5 abuts against the locking block 4, and the locking block 4 extends completely to form a locking structure with the flanging 12 of the housing 1. When unlocking is needed, the conversion handle 8 is pulled in the unlocking direction, and the conversion handle 8 drives the camshaft 7 and the cam 5 to rotate synchronously. When the cam 5 rotates, the portion abutting against the locking block 4 is converted gradually from the short edge 5b to the long edge 5a. During rotation, the reset spring 11 drives the locking block 4 to move backward, and at the unlocking position, the long edge 5a of the cam 5 abuts against the locking block 4. The locking block 4 is retracted completely, and the locking between the locking block 4 and the flanging 12 of the housing 1 is released. In this case, the sliding bracket 2 can be slid for vegetable cutting operation.

The above embodiment is only a preferred embodiment of the present disclosure and does not limit the protection scope of the present disclosure. Therefore, any equivalent changes made based on the structure, shape, principles of the present disclosure should be included within the protection scope of the present disclosure.

What is claimed is:

1. A locking structure of a multi-functional vegetable cutter, comprising a housing and a sliding bracket, wherein
the sliding bracket is slidably disposed in the housing, an upper end of the sliding bracket is provided with a chute with an opening on a front side, a locking block extendable from the opening on the front side is slidably disposed in the chute, a rear side of the locking block is provided with a cam hinged on the sliding bracket, the cam is in abutting connection with a rear end face of the locking block; and
when rotating, the cam drives the locking block to slide forward and lock the sliding bracket, and the locking block is connected to a reset mechanism driving the locking block to slide backward.

2. The locking structure according to claim 1, wherein a rear side of the sliding bracket is provided with a cam seat, a camshaft is rotatably disposed in the cam seat, the cam is fixedly connected to the camshaft, the camshaft is further connected to a conversion handle, and a rear end of the conversion handle extends outside the cam seat.

3. The locking structure according to claim 2, wherein a rear side of the cam seat is detachably connected to a cover plate, and the cover plate and the cam seat enclose a cam mounting chamber.

4. The locking structure according to claim 2, wherein the cam comprises a long edge and a short edge, a transition between the long edge and the short edge is made through a curved edge, when the long edge abuts against the locking block, the sliding bracket is in an unlocked state, and when the short edge abuts against the locking block, the sliding bracket is in a locked state.

5. The locking structure according to claim 2, wherein two sides of the locking block extend outward to form a limiting seat, and a limiting structure is formed between the limiting seat and a front side wall of the chute.

6. The locking structure according to claim 5, wherein the reset mechanism is a reset spring, and the reset spring is disposed between the limiting seat and the front side wall of the chute.

7. The locking structure according to claim 1, wherein an upper end of the housing extends backward to form a flanging, and a lower side surface of the flanging abuts against an upper side surface of the locking block to form a locking structure.

8. The locking structure according to claim 1, wherein the upper end of the sliding bracket is provided with a handheld portion exceeding the sliding bracket.
